(19) United States
(12) Patent Application Publication
(10) Pub. No.: US 2020/0043037 A1
(43) Pub. Date: Feb. 6, 2020

(54) POINT MANAGEMENT SYSTEM AND POINT MANAGEMENT PROGRAM

(71) Applicant: Nomura Research Institute, Ltd., Tokyo (JP)

(72) Inventors: Hiroyuki NAKAMURA, Tokyo (JP); Akira ARAI, Tokyo (JP); Taro MORIOKA, Tokyo (JP); Ryoji KASHIWAGI, Tokyo (JP); Hideaki YASUKAWA, Tokyo (JP)

(21) Appl. No.: 16/597,111

(22) Filed: Oct. 9, 2019

Related U.S. Application Data
(63) Continuation of application No. PCT/JP2018/011157, filed on Mar. 20, 2018.

(30) Foreign Application Priority Data
Apr. 11, 2017 (JP) 2017-078284

(51) Int. Cl. G06Q 30/02

(52) U.S. Cl. CPC G06Q 30/0233

(57) ABSTRACT

A point management system manages points on the basis of an index related to a financial product, the points being held by a user in a loyalty points program with which accumulated points can be exchanged for a product or the like. The point management system includes a point management unit that, on the basis of a target value and/or a withdrawal value of a point balance in management set on the basis of a tiered unit of exchange in exchanging points for a product or the like, calculates information related to prediction of whether or not the point balance reaches each of the target value and/or the withdrawal value by a term, or selects a financial product with which the point balance is highly likely to reach the target value.

### BACKGROUND

### Technical Field

The present invention relates to a technology for a loyalty points program, and more particularly to a technology effectively applied to a point management system that provides a point management service based on a financial index and a point management program.

### Related Art

A loyalty points program by which points are given to a customer being a purchaser according to the purchase amount or the like of a product or service is widely used. The points earned and accumulated by the customer can be, for example, redeemed for a product and the like of a company giving the points or used for payment, and thus have a financial value like money. The points are not only redeemed for a product and the like (or used for purchase thereof) but considered for use in management by being redeemed for a financial product such as stocks. For example, JP 2002-169963 A describes a loyalty points system with which points accumulated by a user can be managed by being mutually exchanged for financial products such as stocks, bonds, investment trusts, and the right to purchase stocks.

### SUMMARY

According to the prior art, a customer can manage and increase the points by mutually exchanging them for the financial products.

On the other hand, in many loyalty points programs, the unit of exchange in exchanging the points accumulated by a customer for a product or the like is set in tiers, which can result in fractional points with respect to an achievable profit (that is, a product or the like available for exchange). As a representative example, in an airline's frequent flyer program, accumulated points (miles) can be exchanged for an airline ticket, where the unit of exchange is set in tiers such as 10,000 miles, 12,000 miles, 15,000 miles, and so on depending on the type and destination of the airline ticket. In this case, for example, even if a customer has accumulated 12,000 miles or more, he can exchange the points for an airline ticket corresponding up to 12,000 miles until the points reach 15,000 miles, whereby the remaining points become fractions.

Moreover, an expiration date is set for the points in many cases. Therefore, merely allowing management of the points by exchanging them for the financial products as in the prior art can often result in a case where a target profit cannot be achieved such as a case where the points do not reach the unit of exchange of a next tier or where the points expire even if the points are increased through the management.

An object of the present invention is to provide a point management system and a point management program for supporting achievement of a target profit through management of points in consideration of a tiered unit of exchange specific to a loyalty points program and an expiration date of points.

The above and other objects and novel features of the present invention will become apparent from the description of the present specification and the accompanying drawings.

The following is a brief description of the outline of a representative one of the inventions disclosed in the present application.

A point management system according to a representative embodiment of the present invention manages points on the basis of an index related to a financial product, the points being held by a user in a loyalty points program with which accumulated points can be exchanged for a product or the like. The point management system includes a point management unit that, on the basis of a target value and/or a withdrawal value of a point balance in management set on the basis of a tiered unit of exchange in exchanging points for a product or the like, calculates information related to prediction of whether or not the point balance reaches each of the target value and/or the withdrawal value by a term, or selects a financial product with which the point balance is highly likely to reach the target value.

The present invention can also be applied to a program that causes a computer to operate as the above point management system.

The following is a brief description of an effect obtained by a representative one of the inventions disclosed in the present application.

That is, a representative embodiment of the present invention can support achievement of a target profit through management of points in consideration of a tiered unit of exchange specific to a loyalty points program and an expiration date of points.

### BRIEF DESCRIPTION OF DRAWINGS

FIG. 1 is a diagram illustrating an outline of an example of the configuration of a point management system as an embodiment of the present invention;

FIG. 2 is a graph illustrating an outline of an example of point management according to an embodiment of the present invention;

FIG. 3 is a flowchart illustrating an example of the flow of point management processing according to an embodiment of the present invention;

FIG. 4 is a diagram illustrating an outline of an example of a screen displayed on a user terminal at the time of point management, according to an embodiment of the present invention;

FIG. 5 is a table illustrating an outline of a data structure of a point balance DB of a point administration system according to an embodiment of the present invention and specific examples of data;

FIG. 6 is a table illustrating an outline of a data structure of a management amount DB according to an embodiment of the present invention and specific examples of data;

FIG. 7 is a table illustrating an outline of a data structure of a management instruction DB according to an embodiment of the present invention and specific examples of data;

FIG. 8 is a table illustrating an outline of a data structure of a financial product management DB according to an embodiment of the present invention and specific examples of data; and

FIG. 9 is a graph illustrating an outline of an example of the relationship between a financial value of points and each of a perceived price and a cost price according to an embodiment of the present invention.

### DETAILED DESCRIPTION

Hereinafter, an embodiment of the present invention will be described in detail with reference to the drawings. Note that in all the drawings for describing the embodiment, the same reference numeral is assigned to the same part in principle, and a repeated description thereof will be omitted. Meanwhile, a part described with a reference numeral in one drawing may be referred to by the same reference numeral in the description of another drawing though not shown again therein.

A point management system as an embodiment of the present invention is an information processing system that allows points earned and accumulated by a user to be managed and increased like a financial product on the basis of a financial index. At this time, a target value is set on the basis of a tiered unit of exchange specific to a loyalty points program, and at the same time a due date for the achievement of the target (that is, a management period) is set. Then, in consideration of an expiration date of points with respect to the due date, the system supports implementation of the management that increases the possibility for the number of points accumulated to reach the target value by the due date.

Note that in the following description, there will be described a case where accumulated points (miles) are exchanged for an airline ticket in a frequent flyer program of an airline as an example of the loyalty points program. That is, the unit of exchange of points is set in tiers such as 10,000 miles, 12,000 miles, and so on where, in each tier, the points can be exchanged for an airline ticket of a different price (value).

### <Overview of Point Management>

FIG. 2 is a graph illustrating an outline of an example of point management according to the present embodiment. In the example of FIG. 2, a curve indicates a change in the balance of points (miles) held by a user over time. Between the beginning and point J, the point balance falls below 10,000 miles which is a first unit of exchange. That is, it is indicated by a bold straight line on the graph that there is no airline ticket for which the points can be exchanged during this period, and that an achievable profit is zero. Then when the point balance exceeds 10,000 miles at point J, it is indicated by a bold straight line that the achievable profit at that point is increased to the tier corresponding to the value of an airline ticket for which 10,000 miles can be exchanged.

After that, it is indicated for example that the management of points is started at point K aiming for the target value of 12,000 miles which is the next unit of exchange, and through fluctuations up to current point L, the points have not reached the target value of 12,000 miles. In this case, the achievable profit during that period is fixed at the value for which 10,000 miles can be exchanged. In other words, a portion held above 10,000 miles becomes a fraction when the points are exchanged for a 10,000-mile airline ticket.

When the point balance reaches 12,000 miles at point M with successful management after current point L, for example, the achievable profit at that point is increased to the tier corresponding to the value of an airline ticket for which 12,000 miles can be exchanged. Then, the management of points is ended with the target value being reached so that a desired airline ticket is acquired by exchange. Even before the maturity of the management period, the management may be ended with the target value being reached so that one can avoid the risk of a drop in the point balance due to a failure in the management thereafter.

On the other hand, when the point balance is decreased to the previous unit of exchange of 10,000 miles at point M due to unsuccessful management after current point L, for example, the same achievable profit as that at the start of management is secured by ending the management of points and exchanging the points for a 10,000-mile airline ticket. In this case, the points held above 10,000 miles being a withdrawal value are lost, or become a fraction even if remained unless the next unit of exchange of 12,000 miles is reached. There is no substantial loss even if the points are lost since the same achievable profit as that at the start of management can be obtained at the minimum.

As described above, the target value and the withdrawal value in terms of the tiered unit of exchange are set for the point balance at the start of management, and when the point balance reaches either of the values, the management is ended by exchanging the points for a corresponding product or the like. As a result, the management can be carried out efficiently by expanding the opportunity of management toward the target value while avoiding a substantial loss of a user and at the same time eliminating the generation of fractional points as much as possible.

### <System Configuration>

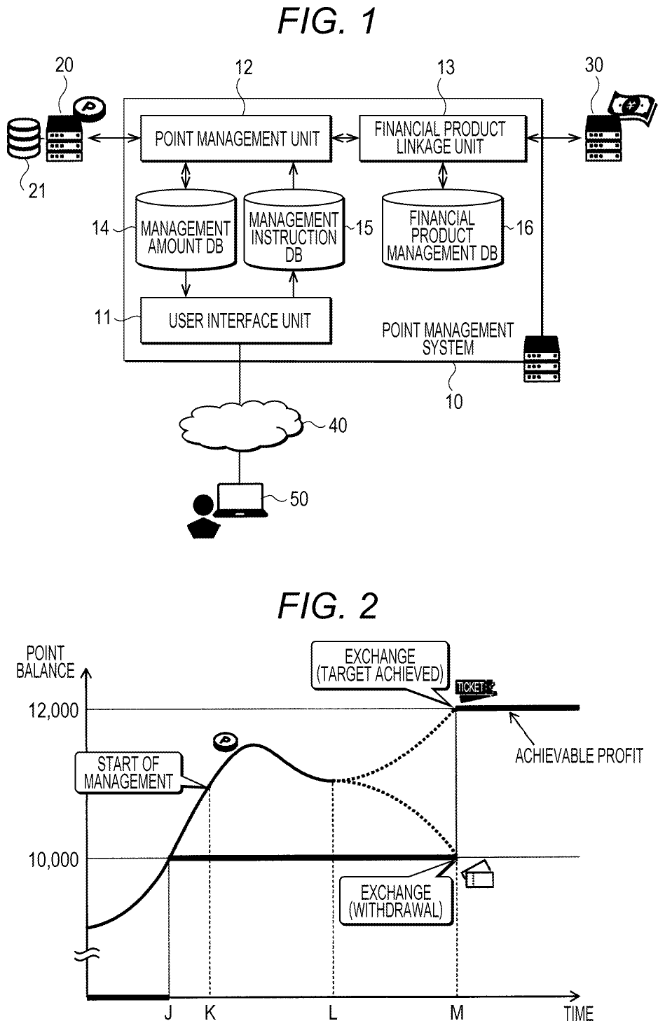

FIG. 1 is a diagram illustrating an outline of an example of the configuration of a point management system as an embodiment of the present invention. A point management system 10 includes, for example, a server system such as a server machine or a virtual server built on a cloud computing service, and is connected to a user terminal 50 being an information processing terminal used by a user via a network 40 such as the Internet. The point management system 10 may also be connected to a point administration system 20 being an information processing system operated and managed by a company or the like that provides a loyalty points program (hereinafter referred to as a “point issuing entity” in some cases) or to a financial product trading system 30 being an information processing system operated and managed by a financial institution or the like that trades financial products via the network 40 or a network such as a local area network (LAN) not shown.

The point management system 10 implements various functions to be described later related to provision of a point management service by running an operating system (OS), middleware such as a database management system (DBMS) or a Web server program, and software running thereon that are developed on a memory from a recording device such as a hard disk drive (HDD) by a central processing unit (CPU) not shown, for example.

The point management system 10 includes units such as a user interface unit 11, a point management unit 12, and a financial product linkage unit 13 implemented as software, for example. The system further includes recording units such as a management amount database (DB) 14, a management instruction DB 15, and a financial product management DB 16 implemented by a database, a file table, and the like.

The user interface unit 11 provides a user interface for displaying, on a screen of a Web browser or dedicated application (not shown) on the user terminal 50, a screen for receiving instructions such as the details and conditions related to the management of points from a user, a screen for presenting information such as a status of management to a user, and the like. The information related to the management instruction received from a user is recorded in the management instruction DB 15. The information such as the status of management is acquired from the management amount DB 14 and displayed. Furthermore, processing such as user authentication or customization for each user may be performed with reference to a user DB (not shown) that holds account information for each user, setting information for each user, and the like.

The point management unit 12 manages points (miles in the present embodiment) according to a financial index related to a financial product (for example, a product with high volatility such as stocks, currency, and crude oil) on the basis of the information on the details and conditions of management for each user set in the management instruction DB 15. The value of the financial index can be acquired, for example, from the financial product trading system 30 via the financial product linkage unit 13 described later, or from an external site, an informational service, or the like via the network 40.

Moreover, when the management instruction is made by a user, information that helps the selection of the financial index (for example, a predicted value of the point balance, a probability of reaching the target value, and the like on the due date when the points are managed in conjunction with the financial index selected) may be calculated by a known method and presented to the user through the user interface unit 11 such that the possibility of reaching the target value is increased. Alternatively, a user may outsource the management of points to an investment advisory organization or the like instead of making the management instruction on his own, in which case the organization or the like makes the management instruction.

The points serving as funds for the management can be checked by referring to the content recorded for each user in the point balance DB 21 of the point administration system 20, for example. A user can also make a credit transaction in which a certain asset or information having a collateral value is set as a collateral besides the points currently held, and the user borrows the points serving as funds for the management first to manage them. For example, when there is a track record of earning a certain number of points or more every year for the past several years in a row, this may be set as a collateral and allow a user to borrow points assuming that the user earns points equivalent to the certain number of points or more in the future.

Alternatively, when the number of points reaches the target value with the points borrowed or points obtained by managing the points borrowed, and a desired product or the like (a reward airline ticket in the present embodiment) is acquired by exchange, the product may be used as a collateral. For example, when the points (miles) reach the target value and a reward airline ticket for a future flight is acquired, the airline ticket may be confiscated if the points borrowed cannot be returned by the boarding date. There can also be used personal information or the like with a financial value such as provision (or permission therefor) of an action history of a user in the future (for example, information useful for marketing such as a purchase history of products or the like and a travel history).

The points may be borrowed from, for example, the point management system 10 (the operating entity thereof) or the point administration system 20 (the point issuing entity). The points may also be borrowed from another user if possible.

An increase or decrease as a result of the management of points may be, for example, balanced at the end of the management (at the time of achievement of the target, withdrawal, or termination of the management period) together with the exchange for a product or the like to be actually reflected in the point balance DB 21 of the point administration system 20 or reflected as needed or on a regular basis.

Note that when a user sets the target value high and gains a high return with successful management (such as when 10,000 miles become 100,000 miles), for example, there is a risk that the burden of cashing out on the original point issuing entity becomes excessive if the points are exchanged for points of another point issuing entity. Therefore, the present embodiment may apply a limitation such that the points provided for the management and the points obtained by the management can only be used in the point exchange service of the original point issuing entity (in the present embodiment, the points can be exchanged only for a reward airline ticket). For example, the point administration system 20 administers target points separately from normal points and performs control to limit the use of the points to the exchange for a reward airline ticket.

The financial product linkage unit 13 manages an actual financial product using the points provided for the management by each user as funds. This part is hidden from the management of points by a user and, for example, allows the point issuing entity to independently manage a financial product using a reserve for the target points as funds. As will be described later, for example, the points provided for the management from each user are added up for each financial product to be managed (for example, stocks, currency, crude oil, or the like), and the points that have been increased are managed by automatically or manually selecting and allocating an optimum category (for example, actuals, futures, options, or the like) for each financial product in consideration of the cost of issuing the points or the like. In this way, instead of exchanging the points provided for the management by the user for a financial product for each user, the points are added up and then exchanged for a financial product collectively by the point issuing entity, whereby fees associated with the trading of financial products can be reduced.

The points may also be managed by a financial product different from a management target specified by a user. For example, while presenting a spot index of stocks, currency, crude oil, or the like to the user, the point issuing entity can avoid incurring a loss by purchasing only the minimum required futures and options in consideration of the cost of issuing the points, the expiration date of the points, and the like. Note that in the point management, the trading of actual financial products may be performed automatically in coordination with the financial product trading system 30.

### <Flow of Processing>

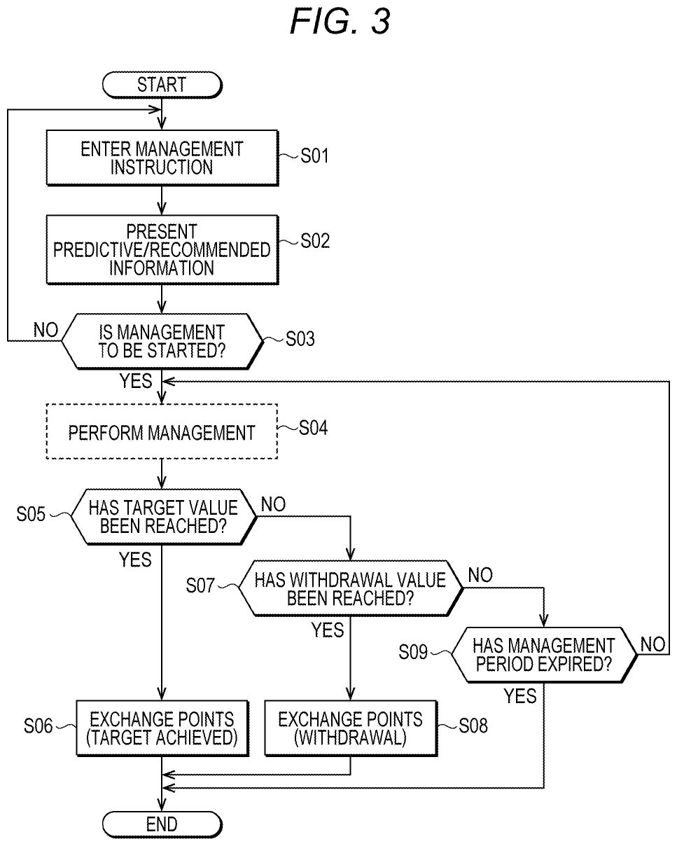

FIG. 3 is a flowchart illustrating an example of the flow of point management processing according to the present embodiment. First, a user accesses the user interface unit 11 of the point management system 10 using the user terminal 50, and enters a part or all of information related to a management instruction via a screen displayed (S01). The point management unit 12 calculates predictive information such as a probability regarding whether or not the point balance reaches the target value or withdrawal value on the basis of the content of the management instruction entered, and displays the information on the user terminal 50 via the user interface unit 11 (S02). Recommended information related to the details of management may be acquired and presented on the basis of the content of the management instruction.

After that, it is determined whether or not the user has instructed start of management via the user terminal 50 (S03). For example, if the user accepts the content of the predictive information related to the point balance, the details of management recommended, and the like displayed on the user terminal 50 in step S02 and has instructed the start of management on the basis of the contents (Yes in S03), the point management is started (S04). At this time, the information on the management instruction accepted is recorded in the management instruction DB 15, and the information on the details of management based thereon is recorded in the management amount DB 14. On the other hand, if the user does not accept the content of the predictive information related to the point balance (No in S03), the processing returns to step S01 to make changes and/or corrections in the content of the management instruction and repeat the processing of recalculating the predictive information, reacquiring the recommended information, and the like.

In the management of step S04, the point balance is increased or decreased in accordance with actual fluctuations of the financial index (crude oil price or the like) of a financial product to be managed, on the basis of the details of the management instruction. As described above, the increase or decrease in the point balance may be, for example, balanced at the end of management and actually reflected in the point balance DB 21 of the point administration system 20, or reflected as needed or on a regular basis.

In addition, the user can access the user interface unit 11 using the user terminal 50 at any time during the management period and refer to the status of management recorded in the management amount DB 14. The user may be allowed to review the content of the management instruction on the basis of the status of management and change the content of the management instruction as needed by the processing similar to that in steps S01 to S03. Moreover, as described above, during the management period, a company or the like as the point issuing entity can for example manage an actual financial product through the financial product linkage unit 13 by using the points provided for management from each user (or the reserve therefor) as funds.

During the management period, it is determined whether or not the point balance has reached the target value as needed (S05). If the point balance has reached the target value (Yes in S05), the achievable profit is settled by exchanging the points with the reached target value as the unit of exchange (S06), whereby the management is ended. On the other hand, if the point balance has not reached the target value (No in S05), it is determined whether or not the point balance has reached the withdrawal value (that is, whether or not the point balance has decreased to the withdrawal value) (S07). If the point balance has reached the withdrawal value (Yes in S07), the minimum achievable profit is secured by exchanging the points with the reached withdrawal value as the unit of exchange (S08), whereby the management is ended.

In exchanging the points, for example, the point management unit 12 instructs the point administration system 20 to exchange points, and the point administration system 20 performs predetermined exchange processing including subtraction of points from the point balance DB 21 and an instruction for shipping a product or the like for which the points are exchanged. Note that instead of automatically exchanging the points and terminating the management, the user may be notified by an e-mail or another means that the target value or withdrawal value has been reached and determine whether or not to actually exchange the points.

If the point balance has not reached the target value or the withdrawal value (No in S07), it is determined whether or not the management period has expired (S09). If the management period has not expired (No in S09), the processing returns to step S04 to continue the management. If the management period has expired (Yes in S09), the management is ended. At this time, with the target value not being reached, the management may be regarded as being unsuccessful so that the minimum achievable profit may be secured by exchanging only the points corresponding to the withdrawal value by the processing similar to step S08.

### <Example of Screen>

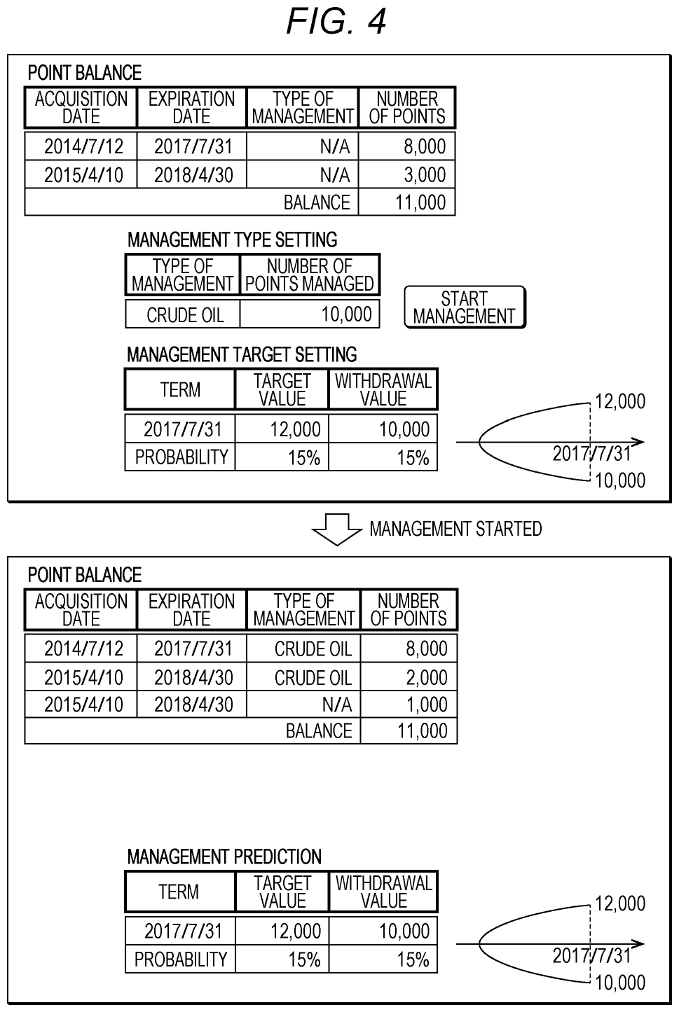

FIG. 4 is a diagram illustrating an outline of an example of the screen displayed on the user terminal 50 at the time of the point management in the present embodiment. The upper figure illustrates an example of the screen when an instruction such as the management condition is entered (steps S01 and S02 of FIG. 3), and the lower figure illustrates an example of the screen when the start of management is instructed after the instruction is entered (Yes in step S03 and step S04 of FIG. 3).

In the example of the screen illustrated in the upper figure, a table labeled “point balance” at the top indicates information on the balance of points currently held by a user. Within the range of this balance, the user specifies the type of management (financial index) and the number of points to be managed in a table labeled “management type setting” in the middle. Moreover, in a table labeled “management target setting” at the bottom, the term of the management (management period) as well as the target value and the withdrawal value of the point balance are specified. Note that with a value being entered in one of the tables, the point management unit 12 may calculate a related value in another one of the tables and set/update the value automatically.

For example, when the number of points managed (10,000 in the example of the figure) is specified in the middle table labeled “management type setting”, the values of the tiered unit of exchange immediately above and below the number of points specified (12,000 and 10,000 in the example of the figure) are acquired among the values of the tiered unit of exchange in the loyalty points program. Then, in the bottom table labeled “management target setting”, the higher one of the values of the tiered unit of exchange acquired is set as the target value, and the lower one is set as the withdrawal value. Note that the user may change the unit of exchange of the target value and the withdrawal value being set to the unit of exchange of another tier.

Moreover, when the type of management (“crude oil” in the example of the figure) is specified in the middle table labeled “management type setting”, for example, a known method may be used to calculate a probability of reaching the target value and the withdrawal value by the term (that is, the expectation for reaching the target value and the risk of falling to the withdrawal value) from expected return “r” and volatility “a” related to a target financial index, and the calculated value can be set as the probability in the bottom table labeled “management target setting”. Instead of the probability, another index related to future prediction may be used as appropriate. Moreover, the status of the prediction for reaching the target value and the withdrawal value may be presented by a graph as illustrated in the lower right of the screen.

Moreover, when the term (2017/7/31 in the example of the figure), the target value, the withdrawal value, and probabilities of reaching these values (expected probability and acceptable probability) are specified by the user in the bottom table labeled “management target setting”, a known method may be used to calculate the type of management and the number of points managed such that the specified value is reached with the specified probability by the specified term, and the calculated values can be set as recommended values in the middle table labeled “management type setting”.

When a value is specified or set in the middle table labeled “management type setting” and the bottom table labeled “management target setting”, and the content is accepted by the user, the user gives an instruction to start managing the points with the content by pressing a “start management” button in the screen (including the case of various operations such as clicking with a mouse not shown and tapping on a touch panel) or the like.

At the start of management and during the subsequent management period, a screen such as the example of the screen illustrated in the lower figure is displayed on the user terminal 50. By referring to such a screen, the user can grasp the details of management, the current point balance, information related to the prediction of a management result, and the like. The example in the figure illustrates that, for the instruction to manage 10,000 miles by “crude oil” as specified in the example of the screen of the management instruction in the upper figure, 8,000 miles with the earlier expiration date of “2017/7/31” are all preferentially allocated to “crude oil” in the end. It also illustrates that a shortage of 2,000 miles is covered by 2,000 miles out of 3,000 miles having the later expiration date of “2018/4/30”, and the remaining 1,000 miles remain unmanaged. Thus, the points approaching the expiration date can be utilized effectively by preferentially allocating the points with the earlier expiration date to the management.

### <Data Structure>

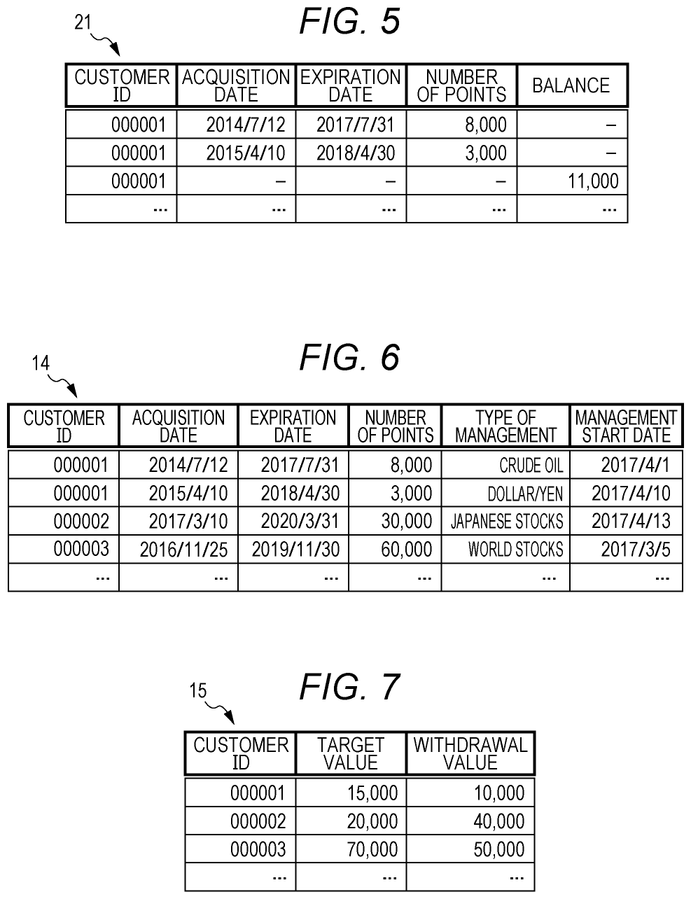

FIG. 5 is a table illustrating an outline of a data structure of the point balance DB 21 of the point administration system 20 of the present embodiment and specific examples of data. The point balance DB 21 is a table for holding information related to the actual balance of points for each user in the point administration system 20 operated and managed by the point issuing entity or the like, and includes items such as “customer ID”, “acquisition date”, “expiration date, “number of points”, and “balance”.

The item “customer ID” holds ID information that uniquely identifies each customer (user). The items “acquisition date” and “expiration date” hold information on the date of acquisition and the date of expiration (expiration date) of points of interest, respectively. The points are identified by the corresponding “expiration dates” (or a combination of “acquisition date” and “expiration date”). The item “number of points” holds information on the total number of points per unit identified by “expiration date” of interest or the like. The item “balance” holds information on the total number of valid points for each user.

The example of FIG. 5 illustrates that a user with “customer ID” of “000001” holds points corresponding to 8,000 miles with “expiration date” of “2017/7/31” and 3,000 miles with “expiration date” of “2018/4/30”. It also illustrates that the user's “balance” is 11,000 miles. Note that in the present embodiment, one special record for holding the value of the total “balance” is provided for each user as in the example, but the method of holing the point balance is not limited thereto.

FIG. 6 is a table illustrating an outline of a data structure of the management amount DB 14 according to the present embodiment and specific examples of data. The management amount DB 14 is a table for holding information on the status of management including the amount of points managed for each user, and has items such as “customer ID”, “acquisition date”, “expiration date”, “number of points”, “type of management”, and “management start date”, for example.

The items “customer ID”, “acquisition date”, “expiration date”, and “number of points” are basically of the same content as the corresponding items in the point balance DB 21 illustrated in FIG. 5 and thus will not be described again. However, while “number of points” in the point balance DB 21 of FIG. 5 holds the information on the total number of points for each unit identified by “expiration date” (or a combination of “acquisition date” and “expiration date”), “number of points” in the management amount DB 14 holds information on the total number of points for each unit identified by the item “type of management” described later in addition to “acquisition date” and “expiration date”. Note that the “total number of points” in this case is a current balance in which a management result is reflected. Therefore, information on the number of points used as the principal for management may be held separately as reference information.

The item “type of management” holds information such as a name or a code value for identifying a financial index by which the points of interest are managed. The item “management start date” holds information on the date when the management of the points of interest is started. The example of FIG. 6 illustrates that, for a user whose “customer ID” is “000001”, for example, points corresponding to 8,000 miles with “expiration date” of “2017/7/31” are managed by “crude oil” from “2017/4/1”, and points corresponding to 3,000 miles with “expiration date” of “2018/4/30” are managed by “dollar/yen” from “2017/4/10”.

FIG. 7 is a table illustrating an outline of a data structure of the management instruction DB 15 according to the present embodiment and specific examples of data. The management instruction DB 15 is a table for holding information on the details and instructions of the management of points for each user, and has items such as “customer ID”, “target value”, and “withdrawal value”, for example. The items “target value” and “withdrawal value” hold values of the unit of exchange being the target value and the withdrawal value of the balance when points are managed, respectively. The example of FIG. 7 illustrates that, for a user whose “customer ID” is “000001”, for example, 15,000 miles is set as the “target value” and 10,000 miles as the “withdrawal value”.

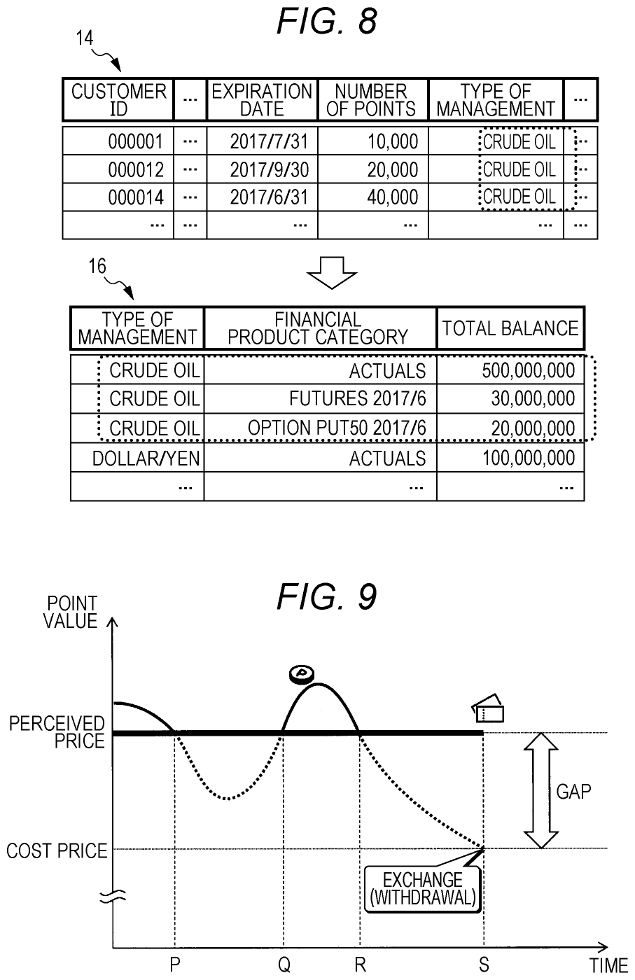

FIG. 8 is a table illustrating an outline of a data structure of the financial product management DB 16 according to the present embodiment and specific examples of data. The financial product management DB 16 illustrated in a lower figure is a table for holding information related to the details of management and the status of management when a point issuing entity or the like manages a financial product using the points provided for management by a user as funds, and has items such as “type of management”, “financial product category”, and “total balance”, for example. The item “type of management” holds information such as a name or a code value for identifying a financial product actually managed. The item “financial product category” holds information such as a name or a code value for identifying the product category of a target financial product. The item “total balance” holds a total value of the balance of the points managed by a target financial product (and product category).

As described above, the financial product linkage unit 13 manages an actual financial product using the points provided for management by each user as funds. At this time, the points provided for management from each user can be added up for each financial product by which the points are managed, and the points that have increased in amount can be managed by being allocated to an optimum category for each financial product in consideration of the cost of issuing the points and the like.

The example of FIG. 8 illustrates that, in the management amount DB 14 in the upper figure, a plurality of users with “customer IDs” of “000001”, “000012”, “000014”, and the like each manages their points while specifying “crude oil” as the financial product. The present embodiment adds the balances of points managed of these users performing the management by “crude oil”, and performs actual management by “crude oil” (or another financial product) using these points as funds. The financial product management DB 16 in the lower figure illustrates that, for “crude oil”, the actual management is performed in different product categories being “actuals”, “futures 2017/6”, and “option PUT 50 2017/6”.

Note that the data structure (items) of each table illustrated in FIGS. 5 to 8 described above is merely an example, where another table structure or data structure may be adopted as long as the structure can hold and administer similar data.

### <Modification>

As illustrated in FIG. 2 and the like above, the present embodiment sets the target value and withdrawal value for the management of points, exchanges the points at the time the point balance reaches either value by the management, and ends the management. Here, for example, the withdrawal value is set to the unit of exchange corresponding to the achievable profit with the point balance at the start of management (10,000 miles in the example of FIG. 2). This can at least prevent the points from falling below the achievable profit secured at the start of management, but on the other hand abandons the possibility that the point balance is increased to reach the target value by the improvement of the status of management thereafter.

On the other hand, while allowing a user to secure at least the achievable profit corresponding to the point balance at the withdrawal value, the actual exchange and settlement of points may be further delayed to expand the opportunity of the point management and keep the possibility of reaching the above target value for a longer time.

For example, although the points held by the user can be said to have a financial value, means for realizing the value as an actual profit is limited to the exchange for a product or the like (a reward airline ticket in the present embodiment). In this case, the value of the points used for the exchange with the product or the like is perceived by the user as the amount of money required when the exchanged product or the like is actually purchased in the market or the like (for example, a list price of the product or the like) (in the following, such amount of money may be referred to as a “perceived price”).

On the other hand, the points are exchanged for the product or the like which has a “cost price”, so that there is a certain gap between the cost price and the user's perceived price. Accordingly, for example, even in the case where the point balance falls further below the withdrawal value in the management of points as described above (in the case of a “loss of principal”), in other words, even in the case where the financial value of the point balance falls below the perceived price of a product or the like exchangeable with the withdrawal value (a reward airline ticket in the present embodiment), the user may be allowed to exchange the points for a target product or the like unless the value falls below the cost price of the target product or the like.

FIG. 9 is a graph illustrating an outline of an example of the relationship between the financial value of points and each of the perceived price and the cost price according to the present embodiment. In the example of FIG. 9, a change in the balance of points held by a user over time is converted into a change in the financial value and indicated by a curve. Between the beginning and point P and between point Q and point R, the financial value of the points exceeds the perceived price of a product or the like exchangeable with the withdrawal value (that is, the point balance exceeds the withdrawal value).

On the other hand, between point P and point Q in the middle, the financial value of the points falls below the perceived price (that is, the point balance falls below the withdrawal value) but is higher than the cost price. When the management method as illustrated in the example of FIG. 2 is employed, the points are exchanged for a product or the like by the perceived price at point P, which abandons the possibility of an increase in the financial value (point balance) by the improvement of the management as between point Q and point R thereafter, for example.

In the present embodiment, the management of points is ended when the point balance is reduced by unsuccessful management and the financial value of the points is eventually reduced to the cost price of a product or the like exchangeable with the withdrawal value at point S, whereby the points are exchanged for the product or the like exchangeable with the withdrawal value. In this case, the user does not incur a loss because, even if the point balance (the financial value of the points) is reduced, he can obtain the product or the like exchangeable with the withdrawal value in the end. On the other hand, the point issuing entity takes over the loss of the user corresponding to the gap between the perceived price and the cost price of the product or the like exchangeable with the withdrawal value and obtains less profit, but can at least avoid a deficit of “below cost”.

Note that in the example of FIG. 9, the financial value of the points to be a reference for ending the management and withdrawing is set to the cost price of the product or the like exchangeable with the withdrawal value of the point balance, but the present embodiment is not limited thereto. The opportunity of the management of points of the user can be expanded as long as the value is a value higher than the cost price (that is, a value at which the point issuing entity does not incur a deficit) and lower than the perceived price of a target product or the like. Moreover, the user can obtain the product or the like exchangeable with the withdrawal value in the end, so that the user need not necessarily be aware of the situation in which the financial value of the points is below the perceived price of a target product or the like (for example, between point P and point Q and between point R and point S in the figure). In the case where the financial value of the points is presented to the user, for example, the perceived price of a target product or the like is presented as an alternative if the value falls below the perceived price of the target product or the like.

As described above, the point management system 10 according to one embodiment of the present invention allows points earned and accumulated by a user to be managed and increased like a financial product on the basis of a financial index. At that time, the target value based on the tiered unit of exchange specific to the loyalty points program and the due date for achieving the target are set, whereby the system can realize the management such that the possibility for the number of points accumulated to reach the target value by the due date increases in consideration of the expiration date of the points with respect to the due date.

Although the invention made by the present inventor has been described specifically on the basis of the embodiment, it is needless to say that the present invention is not limited to the above embodiment but can be modified in various manners without departing from the scope thereof. For example, the above embodiment has been described in detail in order to explain the present invention in an understandable manner, and is not necessarily limited to one including all the configurations described. Moreover, another configuration can be added, deleted, and/or replaced with respect to a part of the configuration of the above embodiment.

A part or all of the above configurations, functions, processing units, processing means, and the like may be implemented by hardware such as by an integrated circuit, for example. Alternatively, the above configurations, functions, and the like may be implemented by software by a processor interpreting and executing a program that implements each function. Information such as programs, tables, files, and the like for implementing each function can be stored in a recording device such as a memory, a hard disk, or a solid state drive (SSD), or in a recording medium such as an IC card, an SD card, or a DVD.

Furthermore, each of the above figures illustrates the control lines and information lines considered to be necessary for the description, and does not necessarily illustrate all the control lines and information lines in the implementation. It may be considered that almost all the configurations are mutually connected in practice.

The present invention is applicable to a point management system that provides a point management service based on a financial index and a point management program.

What is claimed is:

1. A point management system for managing points on the basis of an index related to a financial product, the points being held by a user in a loyalty points program with which accumulated points can be exchanged for a product or the like, and the system comprising
a point management unit that, on the basis of a target value and/or a withdrawal value of a point balance in management set on the basis of a tiered unit of exchange in exchanging points for a product or the like, calculates information related to prediction of whether or not the point balance reaches each of the target value and/or the withdrawal value by a term, or selects a financial product with which the point balance is highly likely to reach the target value.

2. The point management system according to claim 1, wherein
when the point balance reaches the target value or the withdrawal value, the point management unit notifies a user to that effect or exchanges points for a product or the like associated with the unit of exchange corresponding to the target value or the withdrawal value reached.

3. The point management system according to claim 1, further comprising
a financial product linkage unit that manages points provided by a user for management by exchanging the points with a financial product through an information processing system that trades financial products, wherein
the financial product linkage unit exchanges the points provided by the user for management with a financial product different from a financial product specified by the user as an object of management of the points.

4. The point management system according to claim 3, wherein
the financial product linkage unit combines points provided by a plurality of users for management, and manages the points combined by exchanging the points for a predetermined financial product.

5. The point management system according to claim 1, wherein
the point management unit can include points borrowed by a user in points provided by the user for management.

6. The point management system according to claim 2, wherein
the point management unit continues management of the points even when the point balance of the user reaches the withdrawal value and then is further reduced, and when a financial value corresponding to the point balance reaches a predetermined amount, notifies the user to that effect or exchanges the points for a predetermined product or the like.

7. A point management program that causes a computer to execute processing to function as a point management system for managing points on the basis of an index related to a financial product, the points being held by a user in a loyalty points program with which accumulated points can be exchanged for a product or the like, wherein
the computer is caused to execute point management processing that, on the basis of a target value and/or a withdrawal value of a point balance in management set on the basis of a tiered unit of exchange in exchanging points for a product or the like, calculates information related to prediction of whether or not the point balance reaches each of the target value and/or the withdrawal value by a term, or selects a financial product with which the point balance is highly likely to reach the target value.
